(19) United States
(12) Patent Application Publication
(10) Pub. No.: US 2026/0328978 A1
(43) Pub. Date: Oct. 22, 2026

(54) OPTICAL LIMITERS

(71) Applicant: THE SECRETARY OF STATE FOR DEFENCE, Salisbury, Wiltshire (GB)

(72) Inventors: Christopher David Burgess, Salisbury (GB); Francesco Lotti, Salisbury (GB); Anatoly Zayats, Salisbury (GB); Christopher Luke Westgate, Salisbury (GB)

(21) Appl. No.: 19/107,720

(22) PCT Filed: Sep. 1, 2023
(86) PCT No.: PCT/IB2023/058653

§ 371 Date: Feb. 28, 2025

(30) Foreign Application Priority Data
Sep. 2, 2022 (GB) 2212770.8

(51) Int. Cl. G02B 5/22

(52) U.S. Cl. CPC G02B 5/223

(57) ABSTRACT

The present invention provides an optical limiter, comprising optical limiting materials. Said optical limiting materials are capable of providing protection to sensitive optical elements, such as equipment comprising lenses or the lens of a human and/or animal anatomical eye, against laser induced damage.

The present invention is concerned with optical limiters and optical limiting materials, which are devices/materials that are capable of protecting sensitive optical elements from laser induced damage. These optical limiters can be used to protect users from pulses of intense light.

Laser light is a known hazard for eyes and sensitive optical devices. There is a need to protect the user's eyes and sensitive optical devices from high intensity laser beams.

Simultaneously, it is essential in many cases that a protective filter does not hinder the low intensity signals and that it retains high linear transmission.

A number of solutions for spectral filtering exist, such as absorbing dyes and reflective interference coatings, however these solutions require prior knowledge of the incoming laser wavelength to be attenuated in order for the correct dye or interference structure to be used.

Reflective interference coatings also suffer from strong angular dependence of the transmission properties, including notch filters and narrow-band pass filters,

The present invention thus generally aims to provide optical limiters where broad acceptance angles can be achieved and nonlinear responses can be triggered by all wavelengths of visible light in order to provide a novel active, intensity-limiting filter that can be used with lenses and lens arrangements to protect or limit damage to sensitive optical devices or eyes.

Accordingly in a first aspect, the present invention provides an optical limiting material or optical limiter comprising a suspension of nanoparticles wherein the nanoparticles comprise alternating layers of silica and metal, comprising a core of silica or metal and a further bilayer of silica and metal. The nanoparticle may either have a core of metal, upon which there is a layer of silica and a further layer of metal, or alternatively the nanoparticle may have a core of silica upon which there is a layer of metal and a further layer of silica. This new optical limiter is particularly advantageous as it exhibits optical properties that are independent of the angle of incidence, has high linear transmission, and provides strong levels of non-linear attenuation to high-intensity inputs.

A further advantage of the optical limiter of the first aspect is its resilience when stressed to high power laser pulses; the intensity of the laser beam is not only limited by the optical limiter in its entirety, but the nanoparticles undertake a sacrificial function, in that nanoparticles directly illuminated by a laser may be destroyed in the process, allowing other nanoparticles to replace them, as they move in the suspension, for example by means of convection. The high concentration of nanoparticles in suspension means that although some particles may be destroyed (sacrificed) in achieving the optical limiting effect, there would always be sufficient particles in suspension to ensure protection.

Each multishell nanoparticle comprises a minimum of a core of either silica or metal upon which a bilayer of silica and metal is provided, and may further comprise additional bilayers of silica and metal. Such multishell nanoparticles are also plasmonic metamaterials. The core of the optical limiting nanoparticle may be a plasmonic metal such as copper aluminium, silver or gold. Preferably the metal core is gold, as may be the additional metal layers. The metal (gold) core may be surrounded by one, two, three or more bilayers of silica and gold.

There is a noticeable advantage wherein the nanoparticles are most effective as strong non-linear filters when there is either one or two bilayers per nanoparticle.

The suspension may comprise of one nanoparticle type where each particle has the same design parameters, or it could comprise of several nanoparticle types where each type has a different design parameter, for example each layer may have a different parameter or the suspension may have a heterogeneous mix of different nanoparticles. This could be advantageous where one type of nanoparticle may perform better at one wavelength compared to another. Improved protection may be created by mixing at least two particle types together.

Preferably, the nanoparticles are suspended in a liquid having low thermal conductivity and high volatility. Such liquids include Cetrimonium Bromide (CTAB) and APTMS (3-aminopropyl-trimethoxysilane). Alternatively the liquid may be water or deionised water.

The multishell nanoparticles may take various geometrical forms, such as the geometry of a sphere, or the geometry of a cylinder, but preferably the multishell nanoparticles are spherical. The main advantage to having spherical nanoparticles is that the spherical geometry removes the dependence of the intensity limiting on the incident light's direction and polarisation.

Suitable dimensions for the particles, particle core, and subsequent layers will be understood by the person skilled in the art, however the radius of the core may be between 5 and 100 nm, and may for example be 10, 20, 30, 40 or 50 nm. Subsequent layers of metal and silica may range between 5 and 50 nm, such as 10, 20, 30, 40 or 50 nm. The total diameter of the nanoparticles may be between 50 and 500 nm, though this may be dependent on the number of layers and bilayers. A one-bilayer particle (core plus bilayer) may have a diameter of 120 nm, a two-bilayer particle (core plus two bilayers) a diameter of 180 nm, and three bilayer particle (core plus three bilayers) 240 nm. Preferably the thickness of each respective layer has a range of between 1-50 nm, preferably aiming for the total diameter of the nanoparticles to be smaller than the operational wavelength of the laser, where the wavelength of the laser is known, which can be advantageous because the smaller-than-wavelength size means that diffraction effects are minimised. This is required so that the laser interacts with the average effect of the particles, otherwise there are diffraction effects; if the particle size is comparable with the wavelength you will get diffraction.

In a further aspect of the invention, the present invention provides an optical instrument comprising the optical limiter/optical limiting material of the first aspect. Use of the optical limiting material in optical instruments has the advantage of providing the optical instrument, or user of the optical instrument, with enhanced protection from intense pulses of light.

Preferably the optical instrument has a lens arrangement wherein there is provided a focal plane within the optical instrument. The optical limiting material is preferably situated at or near to the focal plane in order to provide protection from intense pulses of light.

In a further embodiment of the invention, the optical limiting material is used for the purpose of limiting the peak output intensity from a wide range of incident energies. The use of the optical limiting material is capable of providing protection from beams of intense light across the visible spectrum and provides the advantage that it does not matter what colour of intense light is shone through, the optical limiting material provides protection against this.

### EXAMPLES

The present invention shall now be discussed with reference to the following non-limiting figures, table and examples, wherein

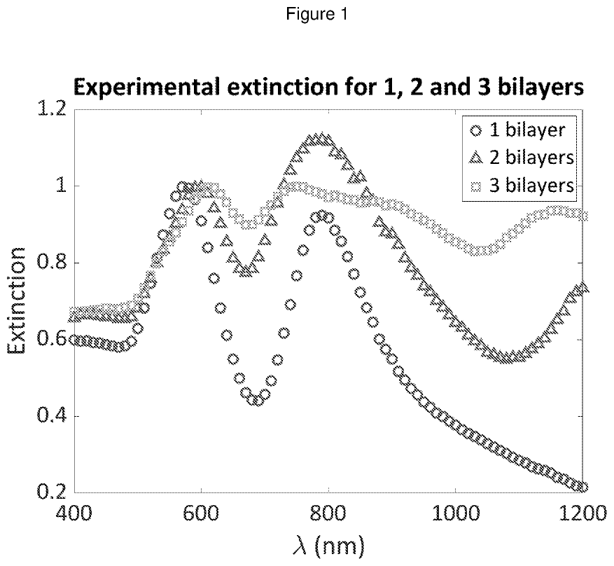

FIG. 1 shows experimental extinction spectra of the one, two and three bilayers nnoparticles as described in Table 1.

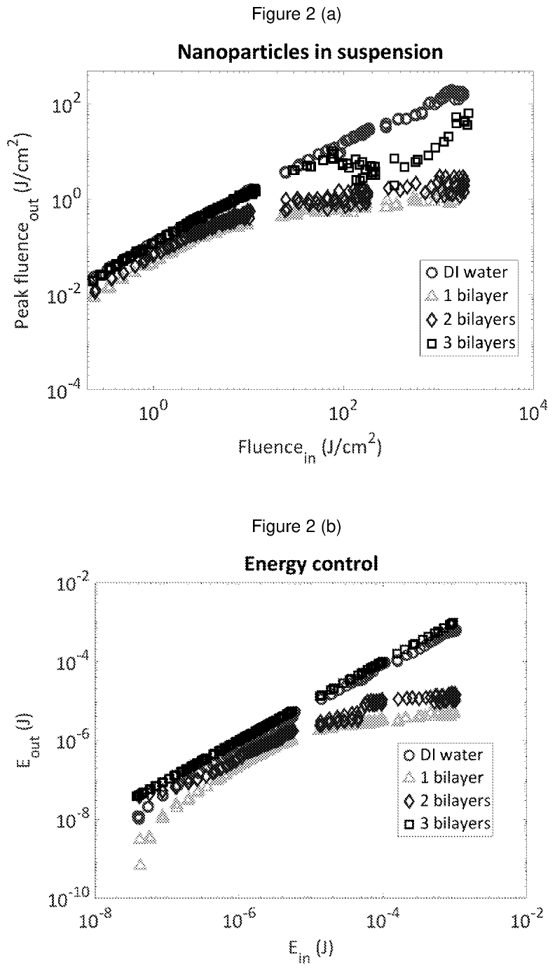

FIG. 2 (a) and (b) shows Nonlinear behaviour of multishells in solutions under illumination at 532 nm: (a) peak fluence transmitted by the sample in function of incident fluence; (b) transmitted energy in function of incident energy, used as a control to understand the nature of the limiting effect shown in (a). The one bilayer and two bilayer systems display very strong intensity limiting due to nonlinear absorption. Several types of multishell nanoparticles have been considered and tested. The core of all nanoparticles generated was a spherical gold nanoparticle which is surrounded by one, two or three bilayers of silica and gold, suspended in deionised (DI) water. The structures have the dimensions shown in Table 1.

Table 1: Dimensions of the nanoparticles used as limiters in suspension. Reported are also the total diameters of the various configurations.

| Parameter | Value (nm) |
|---|---|
| Gold core radius | 30 |
| Silica shells thickness | 10 |
| Gold shells thickness | 20 |
| Total diameter - one bilayer | 120 |
| Total diameter - two bilayers | 180 |
| Total diameter - three bilayers | 240 |

The fabrication of such nanoparticles involves the following procedure: seeds of silica are deposited around a gold core, and eventually coalesce into a layer; this step is then repeated for the gold layer that surrounds the silica layer and so on for the other layers, the structures will be identified by the number of silica-gold bilayers, i.e. 1-bilayer means a spherical gold nanoparticle with a silica shell and an outer gold shell; a 2-bilayers multishell is made of gold-silica-gold-silica-gold from the centre outwards, and so on.

Having regard to FIG. 1, the linear extinction spectra of all multi-layered structures studied is shown. The one bilayer system has two absorption peaks, centred respectively at 575 nm and 790 nm; they display an extinction of 0.8 at 532 nm and 0.3 at 1064 nm. By increasing the number of layers two effects can be seen: a red shift of the absorption resonances and a more complicated spectrum, sign of the stronger contribution of the higher order moments.

Three investigations have been carried out: the first one involved illumination of the suspensions with a 532 nm laser; in the second one the nanoparticles were illuminated by a 1064 nm laser; finally in the third one it was studied how the cuvette's path length affects the nonlinear transmission.

Having regard to FIG. 2 (a) and (b) the results for the 532 nm illumination are shown, compared with the transmission of simple deionised water as a reference. Peak transmitted fluence in function of incident fluence and transmitted energy in function of incident energy is shown. When dealing with camera damage thresholds, peak fluence, i.e. the highest value of fluence measured across the detecting camera, is the relevant quantity at play. As is clear from FIG. 2, the one and two bilayers system act as strong nonlinear filters, limiting the output peak fluence across approximately two orders of magnitude change in input energy, showing the filters perform non-linearly over a wide range of input energies; the energy control plot suggests that they act as absorbers as less energy arrives to the detector. The three bilayers particles are less effective as expected from their linear spectra.

1. An intensity-limiting filter comprising a suspension of nanoparticles, wherein the nanoparticles comprise alternating layers of silica and metal, comprising a core of silica or metal and a further bilayer of silica and metal.

2. An intensity-limiting filter according to claim 1 wherein the core of the nanoparticles is metal.

3. An intensity-limiting filter according to claim 1 wherein the core of the nanoparticles is gold.

4. An intensity-limiting filter according to claim 1 wherein the nanoparticles are spherical.

5. An intensity-limiting filter according to claim 1 wherein a thickness of each layer within the bilayer are within a range of 1 nm to 50 nm.

6. An intensity-limiting filter according to claim 1 wherein a diameter of the core of the nanoparticle is between 10-200 nm.

7. An intensity-limiting filter according to claim 1 wherein a total diameter of the nanoparticle is between 50-500 nm.

8. An optical instrument comprising an intensity-limiting filter according to claim 1.

9. An optical instrument according to claim 8, further comprising a lens arrangement to provide a focal plane for light entering the instrument wherein the intensity-limiting filter is situated at or sufficiently near the focal plane.

10. Use of an intensity-limiting filter according to claim 1, to limit a peak output intensity from a wide range of incident energy.
